(19) United States
(12) Patent Application Publication
(10) Pub. No.: US 2009/0009130 A1
(43) Pub. Date: Jan. 8, 2009

(54) Apparatus and Method for Charging an Accumulator

(76) Inventors: Taco Wijnand Neeb, Nederhorst Den Berg (NL); Ramon Philippe Van Der Hilst, Amsterdam Zuidoost (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(21) Appl. No.: 11/665,341

(22) PCT Filed: Oct. 6, 2005
(86) PCT No.: PCT/NL05/50007

§ 371 Date: Sep. 5, 2008

(30) Foreign Application Priority Data
Oct. 14, 2004 (NL) 1027248

(51) Int. Cl. H01M 10/46; H02J 7/00; H01M 10/44

(52) U.S. Cl. 320/101; 320/138

(57) ABSTRACT

An apparatus for charging an accumulator (1) of electrical charge comprises an apparatus for supplying electrical current from externally supplied energy and for supplying current at an output voltage differential, and terminals for supplying charging current to an accumulator (1) to be charged at an imposed voltage differential. The apparatus is provided with a second accumulator (9) of electrical charge, comprising at least one electrochemical cell, which is connected in series to the apparatus (6) for supplying electrical current between the terminals (2, 3) r such that a voltage differential across the series—connect ion is larger than the output voltage differential of the current—supplying apparatus.

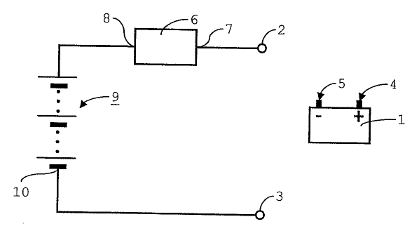

The invention relates to an apparatus for charging an accumulator of electrical charge, comprising

an apparatus for supplying electrical current from externally supplied energy and for supplying current at an output voltage differential, and

terminals for supplying charging current to an accumulator to be charged at an imposed voltage differential.

The invention also relates to a method of charging an accumulator of electrical charge, comprising

supplying electrical current from an external source at an output voltage differential, and

supplying charging current to an accumulator to be charged at an imposed voltage differential.

The invention also relates to the use of an apparatus as described above.

It is known to charge an accumulator or battery by means of a solar panel or other apparatus for supplying electrical current from externally supplied energy, such as a transformer and rectifier, connected to the mains. A problem associated with this is that one is dependent on the supplier of externally supplied energy. In the case of a solar panel, for example, there must be sufficient light. In the case of supply from the mains, the current is usually only cheap outside peak hours.

The invention has as an object to provide an apparatus of the type described above, which reduces in an efficient way the dependence on the external supply of energy.

This object is achieved by the apparatus according to the invention, which is characterised in that,

the apparatus is provided with a second accumulator of electrical charge, comprising at least one electrochemical cell, which is connected in series to the apparatus for supplying electrical current between the terminals, such that a voltage differential across the series-connection is larger than the output voltage differential of the current-supplying apparatus.

Because a second accumulator is connected in series with the apparatus for supplying electrical current, such that a voltage differential across the series-connection is larger than the output voltage differential of the current-supplying apparatus, the apparatus for supplying electrical current need only bridge a small voltage differential. Surprisingly, it has been found that the use of a second accumulator comprising at least one electrochemical cell enables the entire charging apparatus to deliver a relatively high power to the accumulator to be charged. Charging is therefore completed relatively quickly.

In a preferred embodiment, the apparatus for supplying electrical current comprises at least one photovoltaic cell.

This variant has the advantage of being independent of the mains.

Preferably, the apparatus for supplying electrical current comprises a parallel connection of at least two current-generating cells, preferably photovoltaic cells.

In this embodiment, maximum use is made of a certain available surface area of the photovoltaic apparatus. The current supplied by the individual cells is additive, so that a relatively high power is delivered, even at low levels of incident light. This has as a consequence that, even at low levels of incident light, an accumulator can be charged relatively rapidly. The sensitivity is thus improved whilst the charging time is shortened. At very high levels of incident light, the maximum charging voltage of the accumulator to be charged will not easily be surpassed, so that voltage dividers, with resistors that dissipate energy, are superfluous. This effect is also achieved with apparatus that converts incident heat radiation into electrical energy. In, for example, fuel cells, a relatively compact apparatus is obtained by connection in parallel, which still supplies a lot of current.

Preferably, the second accumulator of electrical charge comprises at least one lead-sulphate battery.

This embodiment has the advantage of simplicity. Electrochemical cell supply a well-defined voltage differential, so that the apparatus can readily be designed to supply the charging voltage necessary for the accumulator to be charged.

Preferably, at least one of the electrochemical cells is in a substantially discharged state.

It has surprisingly been found that a very large charging power can thereby be supplied, so that the accumulator to be charged can be charged in a very short period of time. The effect is due to the recovery of the chemical equilibrium in the electrochemical cells of the second accumulator of electrical energy.

Preferably, the current-supplying apparatus is arranged to supply an output voltage differential within a range lying substantially within a range bounded by the difference between the maximum permissible charging voltage and the voltage in discharged, state under load of the accumulator to be charged.

In that way differences in the external supply of energy cannot lead to prolonged exceeding of the maximum charging voltage, or to too low a charging voltage. This improves the efficiency of the apparatus.

In a preferred embodiment, the second accumulator exhibits a voltage differential equal to or greater than a terminal voltage of an accumulator to be charged when in a discharged, state under load.

In that way no additional voltage sources or amplifiers are needed to attain the required charging voltage.

According to another aspect, the method according to the invention is characterised in that

a second accumulator of electrical charge, comprising at least one electrochemical cell, is connected in series to the apparatus for supplying electrical current between the terminals, such that a voltage differential across the series-connection is larger than the output voltage differential of the current-supplying apparatus.

According to another aspect of the invention, the apparatus according to the invention is used for charging an accumulator of electrical charge comprising at least one electrochemical cell, preferably a lead-sulphate battery.

In this way, the externally supplied energy is captured relatively efficiently.

The invention will be explained below with reference to the accompanying drawing, in which an example of an apparatus for charging an accumulator is shown in a very schematic way.

The apparatus shown in the figure is used in the depicted example to charge a battery 1. By this is meant in this context a device comprising at least one electrochemical cell. In the electrochemical cell(s), electrical energy is converted to chemical energy during charging, and chemical energy to electrical energy during discharging. The battery 1 is preferably a lead-sulphate battery, for example a battery for a vehicle. In the cells of such a battery, as is known, the electrodes are made of lead and lead oxide (possibly with additives), and the electrolyte is substantially formed by sulphuric acid. The apparatus is also usable, for example, for charging nickel cadmium batteries and sodium-sulphur batteries. The application in connection with lead-sulphate batteries is advantageous, because the apparatus operates substantially independently of temperature, as will be explained. Lead-sulphate batteries, in particular in the form of vehicle batteries, are also adapted to operate over a large temperature range. Thus, the assembly of the battery to be charged and the charging apparatus is particularly suitable for use in capturing externally supplied energy at remote locations. Other types of battery often require a heating arrangement.

Although the apparatus is preferably used to charge such a battery 1, it is also usable in charging other accumulators of electrical charge. Examples are assemblies of one or more capacitors, for example so-called super capacitors, fuel cells and superconducting current loops.

To charge the battery 1, a first terminal 2 is connected to a positive pole 4 and a second terminal 3 is connected to a negative pole 5 of the battery 1. The positive pole 4 is the pole with, in use, the highest voltage of the two poles 4,5.

Electrical current is supplied by an apparatus for supplying electrical current by conversion of supplied energy. In this example, that apparatus comprises a photovoltaic apparatus 6, which converts light energy into electrical energy. Alternatively, a windmill or thermo-electric apparatus is possible. The former converts kinetic energy into electrical energy, whereas the latter converts heat into electrical energy. Instead of this, a connection to the mains may be realised, wherein the apparatus 6 is replaced by a combination of a transformer and a rectifier. If desired, the apparatus can even comprise a holder for placement of one or more batteries, which are continually replaced when the battery 1 has been charged.

In the shown embodiment, the photovoltaic apparatus 6 also possesses a positive terminal 7 and a negative terminal 8. During current supply, an output voltage differential is established, the voltage difference between the positive terminal 7 and the negative terminal 8, wherein the positive terminal 7 has the higher voltage.

A connection to the mains is not required in the apparatus shown, because the circuit further comprises only a second battery 9. The second battery 9 is connected in series to the photovoltaic apparatus 6, such that the voltage differential across the series connection is larger than the output voltage differential of the photovoltaic apparatus 6. The two voltages are thus additive. Because other active components are absent, the charging voltage equals the sum voltage, bar any voltage drop in the terminals 2,3. The charging apparatus is thus arranged such that the sum voltage is substantially made available across the terminals. The negative pole 5 of the battery 1 to be charged is directly connected to a negative pole 10 of the second battery 9. A variant in which a positive pole of the battery to be charged is directly connected to the positive pole of the second battery, and the apparatus for supplying current is connected between the negative poles, is also possible. Such a variant functions equally well. It has become apparent that direct connection of poles of equal polarity leads to high charging currents, so that the battery 1 to be charged is charged quickly.

The second battery 9 is preferably a lead-sulphate battery, more preferably a traction battery or semi-traction battery. Such a battery has the property that the majority of the energy contents, about eighty percent in the case of a traction battery, for example, and about fifty percent in the case of a semi-traction battery, is effectively usable. This can have been achieved by using a large number of thick lead plates as electrodes, so that a larger part of the sulphate present in the electrolyte is used. The stored energy only becomes available over a relatively longer period, as the battery is less suited to briefly supplying a high current in the way a starter battery is able to. Incidentally, the second battery 9 can also comprise a nickel metal hydride battery or a lithium ion battery, optionally combined with electrolytic capacitors. An electrolyte in the shape of water-soluble salts is thus not necessary to achieve the beneficial effects described herein.

To test the principles of the invention, use was made by way of example of a battery with the following characterising values:

nominal voltage: 12V;

charge capacity: 74 Ah (5 hours);

charge capacity: 90 Ah (20 hours).

This means that the battery can supply a voltage of about twelve volts for five hours at a current of fifteen ampere, or a voltage of about twelve volts for twenty hours at a current of four and a half ampere. Research has shown that the battery shows the same characteristic features during charging. Measurements have further shown that the battery is fully charged after one hour of charging at about twelve volt and forty-five ampere, meaning the open terminal voltage practically doesn't increase further upon further charging. The battery may also be charged at about twelve volt and a hundred-and-fifty ampere. Subsequently, the battery could be discharged at about twelve volt and four and a half ampere in twenty hours.

The open terminal voltage is the yardstick for the energy contents of the battery, provided it is measured after charging, at a point in time when a substantially unvarying equilibrium state has been established. The open terminal voltage of a battery like the exemplary battery, which nominally supplies twelve volts, amounts, in substantially fully charged state, to about 12.8 V. In substantially discharged state, the open terminal voltage amounts to approximately 11.8 V. The battery 9 is included in the apparatus for charging a battery in a state in which the open terminal voltage has a value corresponding to the discharged state, in which the battery normally is not capable of functioning independently as a source of energy. However, by using the configuration as shown in the drawing, the chemical equilibrium in the battery 9 is influenced in such a way that current can nevertheless flow through the battery 9 and the battery 1 to be charged is charged. Incidentally, a voltage difference of 10.8 V is measured for the empty battery under load. During charging a terminal voltage under load of 13.8 V obtains.

In an experiment with the battery characterised above, the empty battery was connected to a load having an open terminal voltage of 11.8 V. After a few hours, the open terminal voltage had decreased to 0.13 V, but after twenty-four hours the substantially unvarying equilibrium state established itself.

The photovoltaic apparatus 6 comprises an assembly of photovoltaic cells (not shown further), which each supply a voltage in the range of 0.35V to 0.65 V, on average 0.45 V. The photovoltaic apparatus 6 comprises a parallel connection of at least two photovoltaic cells. In each branch of the parallel connection a number of photovoltaic cells may be connected in series, to supply an output voltage over the positive and negative terminals 7,8 within the desired range. This desired range lies substantially within a range bounded by the difference between the maximum admissible charge current and the voltage differential in discharged state of the battery 1. For a conventional lead-sulphate battery, for example, the maximum charging current is a value in the range of 12.8 V to 13.8 V. The voltage differential in discharged state is a value in a range about 10.8 V. By connecting at a minimum two, in a certain preferred variant six, photovoltaic cells in series in each branch of the parallel connection it can be ensured that the voltage variations at various light intensities seldom necessitate interruption of the charging process. Alternatively, for brief continuous charging, only one photovoltaic cell may also be included in each branch of the parallel connection. The remaining voltage differential is supplied by the second battery 9. In case the second battery 9 is of the same type as the battery 1 to be charged, and is included in the circuit in discharged state, this is automatically the case, without further control being necessary. It is pointed out that the same principles of the design can be applied to advantage if the photovoltaic apparatus is replaced by a thermovoltaic apparatus, comprising cells that use the Seebeck effect to convert heat into electrical current.

Because only a small number of photovoltaic cells are connected in series, more charge current is generated per unit of surface area. It has even proved possible to charge a battery under moonlight.

During charging with use of the exemplary second battery 9 characterised above, the voltage differential across the second battery 9 collapses during charging. The original voltage differential was restored within a short time after charging. The charged battery 1 naturally exhibited a higher voltage level after charging. With the used apparatus for charging the first battery 1, the energy content of the second battery is used significantly better. This results in an economic advantage.

The shown embodiment has the advantage of being simple. In the example, the second battery 9 is also a lead-sulphate battery, substantially of the same type as the battery to be charged, as mentioned above. This has the advantage that the apparatus is simple to construct. In other embodiments the second accumulator of electrical charge comprises a parallel connection of such batteries, or a series-connection of batteries with a lower nominal voltage differential. The second battery 9 may also be a gel battery. Also, instead of accumulators with electrochemical cells, super-capacitors or fuel cells may be used.

The invention is not limited to the embodiments described above, which may be modified within the scope of the accompanying claims. Relais or other switching elements may be comprised in the circuit, as well as in the photovoltaic apparatus 6. In a certain variant of the method of charging a battery, a pulse, preferably an electrical current pulse, is sent through the second battery 9 after supplying current to the battery 1 to be charged, suitable to reverse formation of crystals at least partly.

1. Apparatus for charging an accumulator of electrical charge, comprising
an apparatus for supplying electrical current from externally supplied energy and for supplying current at an output voltage differential, and
terminals for supplying charging current to an accumulator to be charged at an imposed voltage differential, wherein:
the apparatus is provided with a second accumulator of electrical charge, comprising at least one electrochemical cell, which is connected in series to the apparatus for supplying electrical current between the terminals, such that a voltage differential across the series-connection is larger than the output voltage differential of the current-supplying apparatus.

2. Apparatus according to claim 1, wherein the apparatus for supplying electrical current comprises at least one photovoltaic cell.

3. Apparatus according to claim 1, wherein the apparatus for supplying electrical current comprises a parallel connection of at least two current-generating cells, preferably photovoltaic cells.

4. Apparatus according to claim 1, wherein the second accumulator of electrical charge comprises at least one lead-sulphate battery.

5. Apparatus according to claim 1, wherein the second accumulator of electrical charge comprises at least one traction battery or semi-traction battery.

6. Apparatus according to claim 1, wherein at least one of the electrochemical cells is in a substantially discharged state.

7. Apparatus according to claim 1, wherein one of the terminals connects a positive terminal of a connected accumulator to be charged directly to a positive terminal of the second accumulators.

8. Apparatus according to claim 1, wherein the current-supplying apparatus is arranged to supply an output voltage differential within a range lying substantially within a range bounded by the difference between the maximum permissible charging voltage and the voltage in discharged, state under load of the accumulator to be charged.

9. Apparatus according to claim 8, wherein the second accumulator exhibits a voltage differential equal to or greater than a terminal voltage of an accumulator to be charged when in a discharged, state under load.

10. Method of charging an accumulator of electrical charge, comprising supplying electrical current from an external source at an output voltage differential, and supplying charging current to an accumulator to be charged at an imposed voltage differential, wherein a second accumulator of electrical charge, comprising at least one electrochemical cell, is connected in series to the apparatus for supplying electrical current between the terminals, such that a voltage differential across the series-connection is larger than the output voltage differential of the current-supplying apparatus.

11. Use of an apparatus according to claim 1 to charge an accumulator of electrical charge comprising at least one electrochemical cell, preferably a lead-sulphate battery.
